(19) United States
(12) Patent Application Publication
(10) Pub. No.: US 2025/0372605 A1
(43) Pub. Date: Dec. 4, 2025

(54) ROLLING SYSTEM FOR ELECTRODE PLATE SUBSTRATE

(71) Applicant: SAMSUNG SDI CO., LTD., Yongin-si (KR)

(72) Inventors: Ho Sik SHIN, Yongin-si (KR); Sanghyup MOON, Yongin-si (KR)

(21) Appl. No.: 19/215,720

(22) Filed: May 22, 2025

(30) Foreign Application Priority Data
May 29, 2024 (KR) 10-2024-0070373

(51) Int. Cl. H01M 4/04; H01M 4/66

(52) U.S. Cl. CPC H01M 4/0435; H01M 4/661

(57) ABSTRACT

A rolling system for the electrode plate substrate may include a pair of rolling rolls configured to roll an electrode plate substrate to which an active material is applied. Upstream guide rolls are disposed on an upstream side of the rolling rolls and configured to supply and guide the electrode plate substrate from an unwinder to the rolling rolls. Downstream guide rolls are disposed on a downstream side of the rolling rolls and configured to guide the rolled electrode plate substrate from the rolling rolls to a rewinder to be wound on the rewinder. Scratch rolls may be provided upstream and downstream of the rolling rolls to prevent formation of wrinkles in the electrode plate substrate.

### CROSS-REFERENCE TO RELATED APPLICATION

This application claims priority to and the benefit of Korean Patent Application No. 10-2024-0070373 filed in the Korean Intellectual Property Office on May 29, 2024, the entire contents of which is incorporated herein by reference.

### BACKGROUND OF THE DISCLOSURE

### (a) Field of the Disclosure

The present disclosure relates to a rolling system for making an electrode plate substrate.

### (b) Description of the Related Art

Rechargeable batteries are batteries that repeatedly charge and discharge. Small-capacity rechargeable batteries are used in a portable small electronic devices such as mobile phones, laptop computers, and camcorders. Large-capacity and high-density rechargeable batteries are used for a power source or energy storage for driving motors of hybrid and electric vehicles.

A rechargeable battery includes an electrode assembly for charging and discharging current, a case or pouch accommodating the electrode assembly and an electrolyte, and an electrode terminal connected to the electrode assembly and drawn out of the case or pouch. The electrode assembly may be formed as a jelly roll type formed by winding an electrode and a separator or as a stack type formed by stacking an electrode and a separator.

The process of manufacturing an electrode can substantially affect the characteristics of a battery. In order to improve the density per unit volume of the electrode to which the active material is applied, a rolling process is performed on the electrode plate substrate. For example, when a copper foil substrate forming the negative electrode substrate of a secondary battery is rolled with an ultra-thin film thickness (5 to 6 μm) and a high strength load (450 N/mm²), folds and wrinkles may occur in the negative electrode substrate after rolling. These wrinkles may cause the active material to fall off during the winding process and slitting process of the negative electrode substrate. Also, the longer the length of the uncoated region of the electrode substrate, the more wrinkles may occur.

### SUMMARY OF THE DISCLOSURE

The present disclosure provides a rolling system for an electrode plate substrate capable of preventing formation of wrinkles even after high-speed rolling of an ultra-thin electrode plate substrate. The present disclosure also provides a rolling system for an electrode plate substrate capable of prevent formation of wrinkles upstream and downstream of rolling rolls. Thus, in system according to the disclosure, wrinkles are prevented even after high-speed rolling by roll-pressing of an ultra-thin copper foil substrate used as a negative electrode substrate.

A rolling system for the electrode plate substrate may include a pair of rolling rolls configured to roll an electrode plate substrate to which an active material is applied, upstream guide rolls disposed upstream of the rolling rolls and configured to supply and guide the electrode plate substrate from an unwinder to the rolling rolls, downstream guide rolls disposed downstream of the rolling rolls and configured to guide the rolled electrode plate substrate from the rolling rolls to a rewinder configured to wind the rolled electrode plate substrate, and scratch rolls, with at least one of the scratch rolls being provided upstream of the rolling rolls and at least one of the scratch rolls being provided downstream of the rolling rolls, the scratch rolls being configured to prevent formation of wrinkles in the electrode plate substrate.

The scratch rolls may include two rolls consecutively disposed at a location downstream of the unwinder and upstream of the upstream guide rolls.

The scratch rolls may include two rolls consecutively disposed at a location downstream of the upstream guide rolls and upstream of the rolling rolls.

The scratch rolls may include two rolls consecutively disposed at a location downstream of the rolling rolls and upstream of the downstream guide rolls.

The scratch rolls may include two rolls consecutively disposed downstream of the downstream guide rolls and upstream of the rewinder.

Each of the scratch rolls may be provided with a scratch groove having a symmetrical structure with respect to a center in a length direction of the scratch roll.

The scratch groove may be set at an inclination angle θ with respect to a reference line at the center of the scratch roll.

The inclination angle θ may be formed such that a proceeding part of the scratch groove faces ends of the scratch roll in the length direction such that a force pushing in a width direction of the electrode plate substrate may be generated when the scratch roll guides movement of the electrode plate substrate.

The inclination angle θ may be 11.0 degrees to 12.0 degrees.

The inclination angle θ may be 11.4 degrees.

The scratch groove may have a continuous spiral structure, and may have a pitch P in the length direction.

The scratch groove may be formed in a surface of the scratch roll and has a round shape.

The scratch groove may have a same curvature radius at a central portion and at an end portion in the length direction.

The scratch groove may have a depth that is less than a width of the scratch groove.

The scratch roll may form an accommodation space for the electrode plate substrate such that stress acting on the electrode plate substrate in the length direction may be partially absorbed.

According to another aspect of the disclosure a method of rolling an electrode plate substrate is provided. The method includes guiding the electrode plate substrate in an upstream section to a pair of rolling rolls, rolling the electrode plate substrate with the rolling rolls, and guiding the electrode plate substrate in a downstream section away from the rolling rolls, wherein the electrode plate substrate is applied to at least one scratch roll in the upstream section and at least one scratch roll in the downstream section, with the scratch rolls being configured to prevent the formation of wrinkles in the electrode plate substrate, and the electrode plate substrate may be formed of a copper foil substrate having a thickness of 5 to 6 μm.

The active material coated portion may be formed on the electrode plate substrate by pattern coating, and a length of an uncoated region set along a proceeding direction of the electrode plate substrate is less than a circumferential length of the scratch roll.

According to a further aspect of the disclosure, a rolling system is provided for the electrode plate substrate. The rolling system includes rolling rolls configured to roll an electrode plate substrate to which an active material is applied; guide rolls positioned upstream of the rolling rolls and configured to guide the electrode plate substrate to the rolling rolls; guide rolls positioned downstream of the rolling rolls and configured to guide the rolled electrode plate substrate away from the rolling rolls; at least one upstream grooved roller positioned upstream of the rolling rolls, the at least one groove roller including a groove configured to prevent the formation of wrinkles in the electrode plate substrate; and at least one downstream groove roller positioned downstream of the rolling rolls, the at least one downstream roller including a groove configured to prevent the formation of wrinkles in the rolled electrode plate substrate.

At least two grooved rollers are positioned upstream of the rolling rolls.

At least two grooved rollers are positioned downstream of the rolling rolls.

In embodiments of the disclosure, since a scratch/grooved roll may be provided on at least one of an upstream side and a downstream side of rolling rolls, formation of wrinkles may be prevented even during a process of high-speed rolling of the electrode plate substrate.

### BRIEF DESCRIPTION OF THE DRAWINGS

FIG. 1 is a configurational diagram with respect to an upstream section of rolling rolls in a rolling system for an electrode plate substrate according to an embodiment.

FIG. 2 is a configurational diagram with respect to rolling rolls subsequent to the upstream section of the rolling rolls shown in FIG. 1 in a rolling system for an electrode plate substrate according to an embodiment.

FIG. 3 is a configurational diagram with respect to a downstream section of rolling rolls subsequent to the rolling rolls shown in FIG. 2 in a rolling system for an electrode plate substrate according to an embodiment.

FIG. 4 is a front view of a scratch roll applied to a rolling system for an electrode plate substrate according to an embodiment.

FIG. 5 is a partial detailed view with respect to an arrangement of scratch grooves formed on the scratch roll shown in FIG. 4.

FIG. 6 is a partial detailed view of the scratch groove shown in FIG. 5.

FIG. 7 is an image of a rolling system for an electrode plate substrate according to an embodiment applied with a scratch roll.

### DETAILED DESCRIPTION OF THE EMBODIMENTS

The present disclosure will be described more fully hereinafter with reference to the accompanying drawings, in which embodiments of the disclosure are shown. As those skilled in the art would realize, the described embodiments may be modified in various different ways, all without departing from the spirit or scope of the present disclosure. The drawings and description are to be regarded as illustrative in nature and not restrictive. Like reference numerals designate like elements throughout the specification.

Although terms such as “first,” “second,” and the like are used to explain various constituent elements, the constituent elements are not limited to such terms. These terms are only used to differentiate one constituent element from another.

It is to be understood that when one component is referred to as being “connected” or “coupled” to another component, it may be connected or coupled directly to another component or there may be other intervening components. On the other hand, it is to be understood that when one component is referred to as being “connected or coupled directly” to another component, there are no other intervening components.

Throughout the specification, the terms “comprise” or “have” are intended to specify the presence of stated features, integers, steps, operations, constituent elements, components or a combination thereof, but do not preclude the presence or addition of one or more other features, integers, steps, operations, constituent elements, components, and/or groups thereof. Therefore, unless explicitly described to the contrary, the term “comprise” and variations such as “comprises” or “comprising” will be understood to imply the inclusion of stated elements but not the exclusion of any other elements.

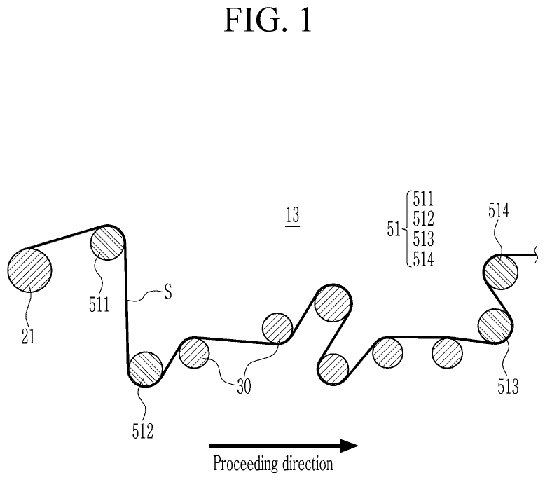

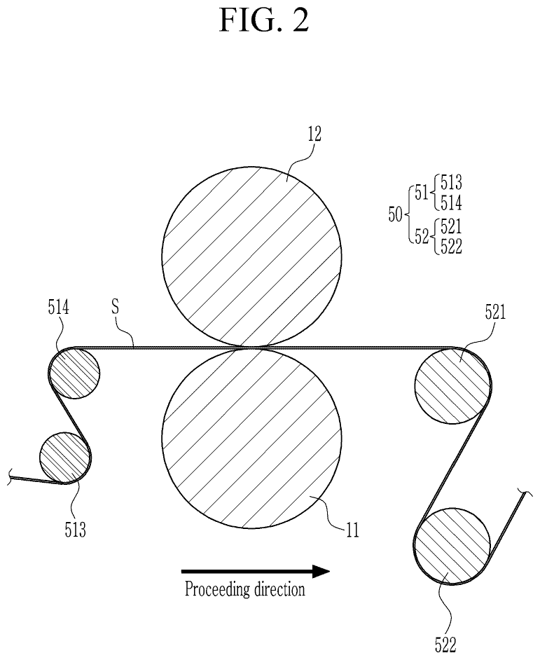

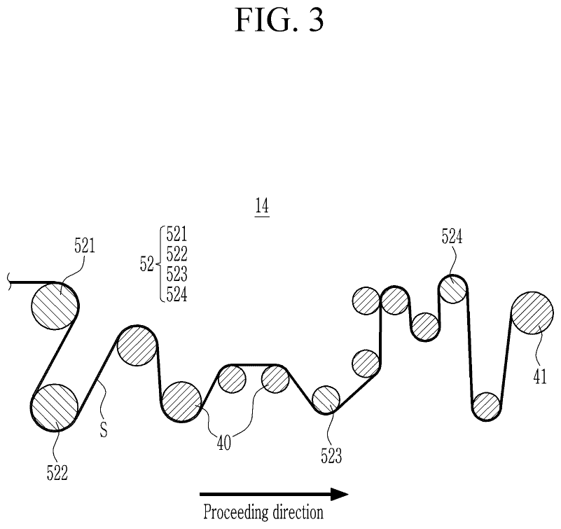

FIG. 1 is a configurational diagram with respect to an upstream section of rolling rolls in a rolling system for an electrode plate substrate according to an embodiment. FIG. 2 is a configurational diagram with respect to rolling rolls subsequent to the upstream section of the rolling rolls shown in FIG. 1 in a rolling system for an electrode plate substrate according to an embodiment. FIG. 3 is a configurational diagram with respect to a downstream section of rolling rolls subsequent to the rolling roll shown in FIG. 2 in a rolling system for an electrode plate substrate according to an embodiment.

Referring to FIG. 1 to FIG. 3, a rolling system for an electrode plate substrate of an embodiment may include a pair of rolling rolls 11 and 12 configured to roll an electrode plate substrate S to which an active material is applied, an upstream section 13 set on an upstream side of the rolling rolls 11 and 12, and a downstream section 14 set on a downstream side of the rolling rolls 11 and 12. Here, the terms “upstream” and “downstream” refer to the direction the electrode plate substrate S is moved through the rolling system.

The upstream section 13 may be a section from where the electrode plate substrate S is fed from an unwinder 21 to the rolling rolls 11 and 12. The downstream section 14 may be a section from where the electrode plate substrate S is rolled and discharged from the rolling rolls 11 and 12 to a rewinder 41. The rolling system is configured to supply and guide an electrode substrate S to be rolled on the upstream side of the rolling rolls 11 and 12 from the unwinder 21 to the rolling rolls 11 and 12, by being providing with the unwinder 21 and upstream guide rolls 30 to the upstream section 13. That is, with downstream guide rolls 40 and the rewinder 41 in the downstream section 14, a rolling system for an electrode plate substrate is configured to guide the electrode substrate S rolled at the downstream side of the rolling rolls 11 and 12 from the rolling rolls 11 and 12 to the rewinder 41 so that the electrode plate substrate is wound on the rewinder 41.

The rolling system for an electrode plate substrate is provided with at least one scratch roll 50 (51) in the upstream section 13, which prevents the formation of wrinkles on the electrode plate substrate S to be rolled. The rolling system is also provided with the at least one scratch roll 50 (52) in the downstream section 14, which prevents the formation of wrinkles on the rolled electrode plate substrate S.

Referring again to FIG. 1 and FIG. 2, scratch (grooved) rolls 51 of the upstream section 13 may include two rolls 511 and 512 consecutively disposed at a location close to the unwinder 21 on the upstream side of the rolling rolls 11 and 12.

When the electrode plate substrate S is supplied from the unwinder 21, the roll 511 and the roll 512 may prevent formation of wrinkles in an early stage of the supply, thereby preventing wrinkles from increasing as the electrode substrate S proceeds through the upstream section 13.

The scratch (grooved) rolls 51 of the upstream section 13 may include two rolls 513 and 514 consecutively disposed at a location close to the rolling rolls 11 and 12, on the upstream side of the rolling rolls 11 and 12. Upstream guide rolls 30 may also be disposed in the upstream section 13.

As the electrode plate substrate S is supplied from the unwinder 21 to the rolling rolls 11 and 12, the scratch (grooved) rolls 513 514 may prevent formation of wrinkles in a late stage of the supply section, thereby removing wrinkles that may have been formed as the electrode plate substrate S moves through the upstream section 13.

Referring again to FIG. 2 and FIG. 3, scratch (grooved) rolls 52 of the downstream section 14 may include two rolls 521 and 522 consecutively disposed at a location close to the rolling rolls 11 and 12 on the downstream side of the rolling rolls 11 and 12.

When the electrode plate substrate S moves away from the rolling rolls 11 and 12 after rolling, the scratch rolls 521 522 may prevent formation of wrinkles in an early stage of the downstream section 14, and thereby prevent wrinkles from increasing as the electrode substrate S proceeds through the downstream section 14.

The scratch (grooved) rolls 52 of the downstream section 14 may also include two rolls 523 and 524 consecutively disposed at a location close to the rewinder 41 on the downstream side of the rolling rolls 11 and 12. The downstream guide rolls 40 also may be disposed in the downstream section 14.

As the electrode plate substrate S moves away from the rolling rolls 11 and 12 to the rewinder 41 after rolling, the rolls 523 and 524 may remove wrinkles in a late stage of the downstream section 14.

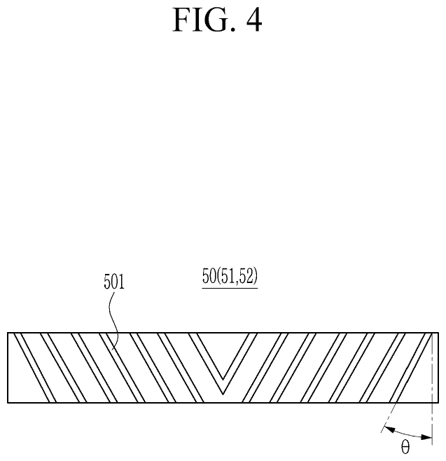

FIG. 4 is a front view of a scratch roll for use in a rolling system for an electrode plate substrate according to an embodiment. Referring to FIG. 4, scratch rolls 50 may be provided with scratch grooves 501 having a symmetrical structure on both left and right sides with respect to a center in a length direction of the scratch rolls 50.

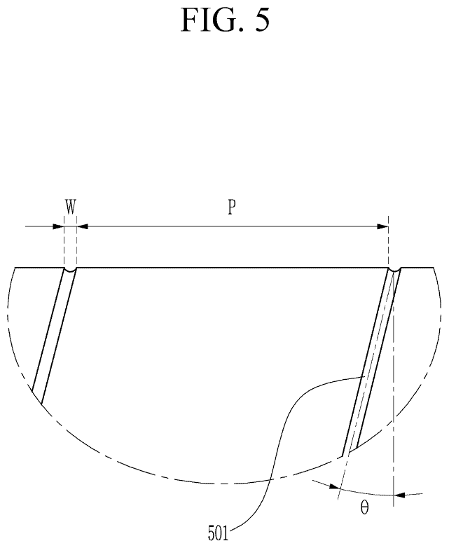

FIG. 5 is a partial detailed view of the arrangement of scratch grooves formed on the scratch roll shown in FIG. 4. Referring to FIG. 4 and FIG. 5, when a direction perpendicular to the length direction is used as a reference line, the scratch grooves 501 may have an inclination angle θ with respect to the reference line in the symmetrical structure.

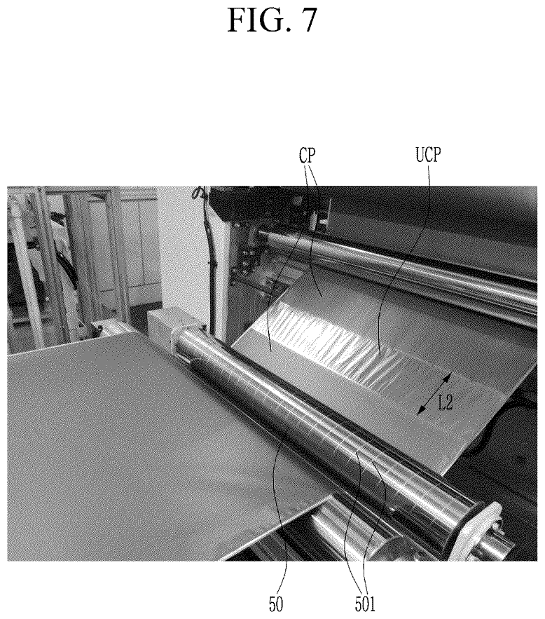

When an active material coated portion CP (see FIG. 7) is pattern coated on the electrode plate substrate S, and when the inclination angle θ of the scratch groove 501 is set to 6.2 degrees and 8.4 degrees, fine wrinkles may occur in a central portion of an uncoated region with respect to a width direction of the electrode plate substrate. Also, when the inclination angle θ is set to 13.5 degrees, 17.8 degrees, and 20.3 degrees, fine wrinkles may occur in an edge portion of the uncoated region with respect to the width direction of the electrode plate substrate. But it was found that when the active material coated portion CP is a pattern coating on the electrode plate substrate S, and when the inclination angle θ of the scratch groove 501 is set to 11.4 degrees, the amount of wrinkling was reduced. Thus, in the case that the inclination angle θ is set to 11.0 degrees to 12.0 degrees, it is predicted that wrinkling will be reduced.

The inclination angle θ in symmetrical structure may be formed such that the sections of the scratch roll proceeding of the scratch groove 501 may face both ends of the scratch roll 50 in the length direction. Thus, a force is generated that pushes the electrode plate substrate S in its width direction (length direction of the scratch roll) as the scratch roll guides movement of the electrode plate substrate S.

Thus, the electrode plate substrate S guided by the guide rolls 30 and 40 may receive forces pushing the electrode plate substrate toward both ends of the width direction (length direction of the scratch roll). Further, wrinkles may be prevented from occurring in the electrode plate substrate S even as it proceeds in the direction for rolling as the stress acting on the electrode plate substrate S in the width direction is alleviated by the scratch groove 501.

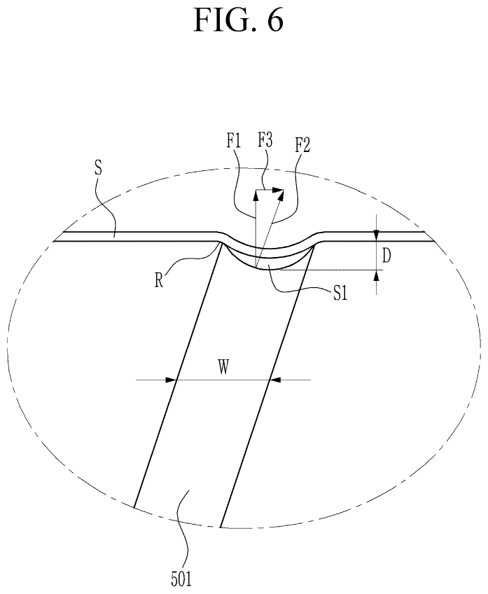

the scratch groove 501 of the scratch roll 50 may form an accommodation a space S1 (see FIG. 6) for the electrode plate substrate S such that stress acting on the electrode plate substrate S in the length direction of the scratch roll 50 may be partially absorbed. Thus, a portion of the electrode plate substrate S is partially accommodated in the scratch groove 501, and, accordingly, potentially damaging stress in the electrode plate substrate S may be removed.

FIG. 6 is a partial detailed view of the scratch groove of FIG. 5. Referring to FIG. 4 to FIG. 6, the scratch groove 501 has a continuous spiral structure and has a pitch P in the length direction.

The scratch groove 501 may be formed in a surface of the scratch roll 50 in a round shape. The scratch groove 501 may have a same curvature radius R at a central portion of the scratch roll 50 as at end portions of the scratch roll 50 in the length direction. But, in other embodiments not shown in the drawings, the curvature radius of the scratch groove 501 may be different formed at central portion and at the end portions in the length direction of the scratch roll 50. The curvature radius R may prevent the damage to the electrode plate substrate S by the scratch groove 501.

The scratch groove 501 may have a depth D that is less than a width W. The space S1 defined by the width W and the depth D may decrease the stress applied to the electrode plate substrate S. The stress decrease of the electrode plate substrate S may prevent and/or reduce formation of wrinkles.

In an example embodiment, when the pitch P of the scratch groove 501 is 30 mm, the width W of the scratch groove 501 may be 1 mm. The pitch P and the width W of the scratch groove 501 may be adjusted as necessary to decrease stress in the electrode plate substrate S.

The space S1 may be appropriately sized with respect to the proceeding speed of the electrode plate substrate S, the frictional force of the scratch roll 50, and tensile strength of the electrode plate substrate S. A larger the space S1 corresponds to a lower tensile strength of the electrode plate substrate S, but if it is excessively large, the frictional force image by the scratch roll 50 may be too small. When the space S1 is too small, the reduction efficiency of the tensile strength and the frictional force may be minimal. The entire space S1 may be set according to the pitch P and the width W in the scratch roll 50.

Meanwhile, as the electrode plate substrate S receives the tensile force from the scratch roll 50, the electrode plate substrate S receives a first force F1 in the scratch groove 501. Because of the inclination angle θ of the scratch groove 501, the first force F1 includes a second force F2 component acting in the direction of the inclination angle θ and a third force F3 component perpendicular to the first force F1 and acting in the length direction of the scratch roll 50, i.e., the width direction of the electrode plate substrate S. The third force component F3 pushes an uncoated region UCP of the electrode plate substrate S in the length direction of the scratch roll 50, i.e., the width direction of the electrode plate substrate S. Accordingly, the uncoated region UCP may have its stress alleviated by the scratch groove 501 and may be pushed. Thus, wrinkles may be prevented in the uncoated region UCP.

FIG. 7 is an image of a rolling system for an electrode plate substrate according to an embodiment applied with a scratch roll. Referring to FIG. 7, the electrode plate substrate S has a thickness of 5 to 6 μm, the active material coated portion CP is a pattern coated on the electrode plate substrate S, and a length L2 of the uncoated region UCP set along the proceeding direction of the electrode plate substrate S is less than a circumferential length of the scratch roll 50. Thus, the coated portion CP may simultaneously contact the scratch roll 50, and accordingly, the frictional force between the electrode plate substrate S and the scratch groove 501 may be maintained at an appropriate level. Accordingly, wrinkles may be effectively prevented on both sides of the uncoated region UCP supported by the coated portion CP.

While this disclosure has been described in connection with what is presently considered to be practical embodiments, it is to be understood that the disclosure is not limited to the disclosed embodiments. Rather, the disclosure covers various modifications and equivalent arrangements.

<Description of symbols>

| | |
|---|---|
| 11, 12: rolling roll | 13: upstream section |
| 14: downstream section | 21: unwinder |
| 41: rewinder | 30: upstream guide roll |
| 40: downstream guide roll | 50, 51, 52: scratch roll |
| 501: scratch groove | 511: eleventh roll |
| 512: twelfth roll | 513: thirteenth roll |
| 514: fourteenth roll | 521: twenty-first roll |
| 522: twenty-second roll | 523: twenty-third roll |
| 524: twenty-fourth roll | CP: coated portion |
| D: depth | F1: first force |
| F2: second force | F3: third force |
| R: curvature radius | S: electrode plate substrate |
| S1: space | UCP: uncoated region |
| W: width | θ: inclination angle |

What is claimed is:

1. A rolling system for the electrode plate substrate, the rolling system comprising:
a pair of rolling rolls configured to roll an electrode plate substrate to which an active material is applied;
upstream guide rolls disposed upstream of the rolling rolls and configured to supply and guide the electrode plate substrate from an unwinder to the rolling rolls;
downstream guide rolls disposed downstream of the rolling rolls and configured to guide the rolled electrode plate substrate from the rolling rolls to a rewinder configured to wind the rolled electrode plate substrate; and
scratch rolls, with at least one of the scratch rolls being provided upstream of the rolling rolls, and with at least one of the scratch rolls being provided downstream of the rolling rolls, the scratch rolls being configured to prevent formation of wrinkles in the electrode plate substrate.

2. The rolling system of claim 1, wherein the scratch rolls comprise two rolls consecutively disposed at a location downstream of the unwinder and upstream of the upstream guide rolls.

3. The rolling system of claim 1, wherein the scratch rolls comprise two rolls consecutively disposed at a location downstream of the upstream guide rolls and upstream of the rolling rolls.

4. The rolling system of claim 1, wherein the scratch rolls comprise two rolls consecutively disposed at a location downstream of the rolling rolls and upstream of the downstream guide rolls.

5. The rolling system of claim 1, wherein the scratch rolls comprise two rolls consecutively disposed at a location downstream of the downstream guide rolls and upstream of the rewinder.

6. The rolling system of claim 1, wherein each of the scratch rolls is provided with a scratch groove having a symmetrical structure with respect to a center in a length direction of the scratch roll.

7. The rolling system of claim 6, wherein the scratch groove is set at an inclination angle θ with respect to a reference line at the center of the scratch roll.

8. The rolling system of claim 7, wherein the inclination angle θ is formed such that a proceeding part of the scratch groove faces ends of the scratch roll in the length direction such that a force pushing in a width direction of the electrode plate substrate is generated when the scratch roll guides movement of the electrode plate substrate.

9. The rolling system of claim 7, wherein the inclination angle θ is 11.0 degrees to 12.0 degrees.

10. The rolling system of claim 9, wherein the inclination angle θ is 11.4 degrees.

11. The rolling system of claim 7, wherein the scratch groove has a continuous spiral structure and has a pitch P in the length direction.

12. The rolling system of claim 11, wherein the scratch groove is formed in a surface of the scratch roll and has a round shape.

13. The rolling system of claim 12, wherein the scratch groove has a same curvature radius at a central portion and at an end portion in the length direction.

14. The rolling system of claim 11, wherein a depth of the scratch groove is less than a width of the scratch groove.

15. The rolling system of claim 11, wherein the scratch roll forms an accommodation space for the electrode plate substrate such that stress acting on the electrode plate substrate in the length direction is at least partially absorbed.

16. A method of rolling an electrode plate substrate, the method comprising:
guiding the electrode plate substrate in an upstream section to a pair of rolling rolls,
rolling the electrode plate substrate with the rolling rolls, and
guiding the electrode plate substrate in a downstream section away from the rolling rolls,
wherein the electrode plate substrate is applied to at least one scratch roll in the upstream section and at least one scratch roll in the downstream section, the scratch rolls being configured to prevent the formation of wrinkles in the electrode plate substrate, and
wherein the electrode plate substrate is formed of a copper foil substrate having a thickness of 5 to 6 μm.

17. The method of claim 15, wherein the active material coated portion is formed on the electrode plate substrate by pattern coating, and
wherein a length of an uncoated region set along a proceeding direction of the electrode plate substrate is less than a circumferential length of the scratch roll.

18. A rolling system for the electrode plate substrate, the rolling system comprising:
rolling rolls configured to roll an electrode plate substrate to which an active material is applied;
guide rolls positioned upstream of the rolling rolls and configured to guide the electrode plate substrate to the rolling rolls;
guide rolls positioned downstream of the rolling rolls and configured to guide the rolled electrode plate substrate away from the rolling rolls;
at least one upstream grooved roller positioned upstream of the rolling rolls, the at least one groove roller including a groove configured to prevent the formation of wrinkles in the electrode plate substrate; and
at least one downstream groove roller positioned downstream of the rolling rolls, the at least one downstream roller including a groove configured to prevent the formation of wrinkles in the rolled electrode plate substrate.

19. The rolling system of claim 18, wherein at least two grooved rollers are positioned upstream of the rolling rolls.

20. The rolling system of claim 18, wherein at least two grooved rollers are positioned downstream of the rolling rolls.
